(19) United States
(12) Patent Application Publication
(10) Pub. No.: US 2026/0181096 A1
(43) Pub. Date: Jun. 25, 2026

(54) IMAGE FORMING APPARATUS AND CONTROL METHOD FOR IMAGE FORMING APPARATUS

(71) Applicant: SHARP KABUSHIKI KAISHA, Osaka (JP)

(72) Inventor: Naoki HASEGAWA, Osaka (JP)

(21) Appl. No.: 19/421,695

(22) Filed: Dec. 16, 2025

(30) Foreign Application Priority Data
Dec. 19, 2024 (JP) 2024-224078

(51) Int. Cl. H04N 1/32; H04N 1/00

(52) U.S. Cl. CPC H04N 1/3263; H04N 1/00543; H04N 1/00604; H04N 1/00411; H04N 2201/0094

(57) ABSTRACT

An image forming apparatus includes: at least one controller; a first feed tray that accommodates a sheet; a second feed tray that accommodates a sheet; and a display, wherein the at least one controller stops, when a jam occurs and the first feed tray is a feed source, conveyance of the sheet, displays a feed tray opening/closing request message, prompting opening and closing of the first feed tray, on the display, and then resumes the conveyance of the sheet, and stops, when the jam occurs and the second feed tray is the feed source, the conveyance of the sheet, and then resumes the conveyance of the sheet without displaying a message prompting opening and closing of the second feed tray on the display.

### CROSS-REFERENCE TO RELATED APPLICATION

The present application claims priority from Japanese Application JP2024-224078, the content of which is hereby incorporated by reference into this application.

### BACKGROUND OF THE INVENTION

### 1. Field of the Invention

The disclosure relates to an image forming apparatus and the like.

### 2. Description of the Related Art

In general, in an image forming apparatus, a feed tray in which a sheet is set is housed inside a housing, the sheet is picked up from the feed tray and conveyed on a feed path to an image former, and an image is formed on the sheet in the image former. In the image forming apparatus, when a sheet is conveyed, a jam of the sheet on the feed path or the like may occur. In view of this, there is an image forming apparatus that displays a guidance screen indicating a method of removing a jammed sheet on a display when the occurrence of a jam is detected.

According to a known way of coping with a trouble that has occurred, a method of solving the trouble is sequentially displayed on a screen, and finally, a display is provided to a user to check a portion expected to be a cause of the trouble.

### SUMMARY OF THE INVENTION

Cases where sheet conveyance fails include a case where a sheet fails to be picked up from a feed tray due to a failure to appropriately set the sheet on the feed tray, resulting in the sheet conveyance failure, in addition to the case where a sheet on a feed path is jammed. With the known image forming apparatus, a guidance screen appropriately addressing such a pickup failure of the sheet from the feed tray has not been displayed.

An object of the disclosure is to provide an image forming apparatus that displays guidance according to a feed tray as a feed source when a jam occurs.

The disclosure provides an image forming apparatus including: at least one controller; a first feed tray that accommodates a sheet; a second feed tray that accommodates a sheet; and a display, wherein the at least one controller stops, when a jam occurs and the first feed tray is a feed source, conveyance of the sheet, displays a feed tray opening/closing request message, prompting opening and closing of the first feed tray, on the display, and then resumes the conveyance of the sheet, and stops, when the jam occurs and the second feed tray is the feed source, the conveyance of the sheet, and then resumes the conveyance of the sheet without displaying a message prompting opening and closing of the second feed tray on the display.

The disclosure further provides a control method for an image forming apparatus including a first feed tray that accommodates a sheet, a second feed tray that accommodates a sheet, and a display, the method including: stopping, when a jam occurs and the first feed tray is a feed source, conveyance of the sheet, displaying a feed tray opening/closing request message, prompting opening and closing of the first feed tray, on the display, and then resuming the conveyance of the sheet; and stopping, when the jam occurs and the second feed tray is the feed source, the conveyance of the sheet, and then resuming the conveyance of the sheet without displaying a message prompting opening and closing of the second feed tray on the display.

The disclosure can provide an image forming apparatus that displays guidance according to a feed tray as a feed source when a jam occurs.

### BRIEF DESCRIPTION OF THE DRAWINGS

FIG. 1 is an external perspective view of an image forming apparatus according to a first embodiment of the disclosure.

FIG. 2 is a schematic cross-sectional view of the image forming apparatus according to the first embodiment of the disclosure.

FIG. 3A is a diagram illustrating a feed tray accommodated in the image forming apparatus according to the first embodiment of the disclosure, and is an external perspective view of the feed tray.

FIG. 3B is a diagram illustrating the feed tray accommodated in the image forming apparatus according to the first embodiment of the disclosure, and is a schematic cross-sectional view of the feed tray.

FIG. 4 is a block diagram of the image forming apparatus according to the first embodiment of the disclosure.

FIG. 5 is a block diagram of a controller of the image forming apparatus according to the first embodiment of the disclosure.

FIG. 6 is a block diagram of a storage of the image forming apparatus according to the first embodiment of the disclosure.

FIG. 7A is a flowchart illustrating an operation of an image forming apparatus according to the first embodiment of the disclosure, and is a flowchart illustrating an operation performed when a first conveyance sensor detects a sheet.

FIG. 7B is a flowchart illustrating an operation of the image forming apparatus according to the first embodiment of the disclosure, and is a flowchart illustrating an operation performed in accordance with a change in an open/closed state of a feed tray.

FIG. 8 is a photograph of the feed tray as viewed from above, and is a diagram illustrating a gap between a sheet trailing end and a sheet trailing end guide.

FIG. 9A is a schematic cross-sectional view illustrating how a lifted-up sheet moves in a spring-type feed tray, and illustrates a state before the sheet is lifted up.

FIG. 9B is a schematic cross-sectional view illustrating how the lifted-up sheet moves in the spring-type feed tray, and illustrates a state immediately after the sheet has been lifted up.

FIG. 9C is a schematic cross-sectional view illustrating how the lifted-up sheet moves in the spring-type feed tray, and illustrates a state after the lifted sheet has slipped off and moved.

FIG. 10 is a diagram illustrating a positional relationship between a sheet lifted up on a feed tray and a conveyance sensor.

FIG. 11 is a schematic view illustrating transition of a screen of the image forming apparatus according to the first embodiment of the disclosure.

FIG. 12A illustrates an example of a screen displayed by the image forming apparatus according to the first embodiment of the disclosure, and illustrates an example of a jam map screen.

FIG. 12B illustrates an example of a screen displayed by the image forming apparatus according to the first embodiment of the disclosure, and illustrates an example of a screen illustrating a procedure for closing a bypass tray.

FIG. 13A illustrates an example of a first guidance screen displayed by the image forming apparatus according to the first embodiment of the disclosure, and illustrates an example of a screen illustrating how to open a conveyance cover (right side cover).

FIG. 13B illustrates an example of a first guidance screen displayed by the image forming apparatus according to the first embodiment of the disclosure, and illustrates a procedure for taking out the jammed sheet from the inside of a housing.

FIG. 14 illustrates an example of a second guidance screen displayed by the image forming apparatus according to the first embodiment of the disclosure.

FIG. 15 is a block diagram of an image forming apparatus according to a second embodiment of the disclosure.

FIG. 16 is a schematic cross-sectional view of the image forming apparatus according to the second embodiment of the disclosure.

FIG. 17 is a flowchart illustrating an operation of the image forming apparatus according to the second embodiment of the disclosure.

FIG. 18 is a flowchart illustrating an operation of the image forming apparatus according to the second embodiment of the disclosure.

FIG. 19 is a flowchart illustrating an operation of the image forming apparatus according to the second embodiment of the disclosure.

FIG. 20 is a flowchart illustrating an operation of the image forming apparatus according to the second embodiment of the disclosure.

FIG. 21 is a flowchart illustrating an operation of an image forming apparatus according to a third embodiment of the disclosure.

### DETAILED DESCRIPTION OF THE INVENTION

In the disclosure, when a paper jam occurs, first, a guidance prompting opening and closing of a conveyance cover for checking the jammed sheet on the feed path is displayed, and then, a guidance prompting opening and closing of the feed tray for checking the positions of the sheet and a sheet trailing end guide is displayed, thereby improving processing executed when there is a gap between the sheet trailing end guide and the sheet trailing end.

Depending on the feed tray, the accommodated sheet may be shifted toward the trailing end side upon being lifted up. In the disclosure, when a paper jam occurs in an image forming apparatus including this type of feed tray, the conveyance of the sheet is temporarily stopped, and (1) a first guidance screen is displayed to prompt a user to open the conveyance cover to check the feed path and then close the conveyance cover. The first guidance screen includes a message prompting the user to open the conveyance cover and check the inside of a housing. The conveyance of the sheet is not resumed immediately after the display of the first guidance screen. Next, (2) a second guidance screen is displayed to prompt the user to open the feed tray, check the state of the sheet in the feed tray, the position of the sheet trailing end guide, and the like, and then close the feed tray. The second guidance screen includes a feed tray opening/closing request message for prompting opening and closing of the first feed tray. After the second guidance screen is displayed, the conveyance of the sheet is resumed in accordance with a change in the open/closed state of the feed tray. This enables the user to resume the conveyance of the sheet after the user has reliably checked the state of the sheet in the feed tray and the state of the sheet trailing end guide.

In order to realize such an operation, in the disclosure, a variable “tray checking necessity status” is given to the feed tray. When the value of the tray checking necessity status is ON, it indicates that the feed tray needs to be checked, and when the value is OFF, it indicates that the feed tray does not need to be checked. When the tray checking necessity status is ON, the controller of the image forming apparatus prohibits the start of conveyance of the sheet. When the open/closed state of the feed tray transitions from the open state to the closed state with the second guidance screen displayed, the controller changes the value of the tray checking necessity status from ON to OFF.

In the disclosure, the term “jam” includes a state in which a sheet is not actually conveyed even though the sheet conveyance is executed by the conveyor, in addition to a state in which a sheet on a feed path is jammed or the like. Specifically, the “jam” includes a state in which a sheet is not conveyed because the sheet fails to be picked up from the feed tray for some reason, while the sheet conveyance is executed.

### 1. First Embodiment

### 1.1 Overall Configuration

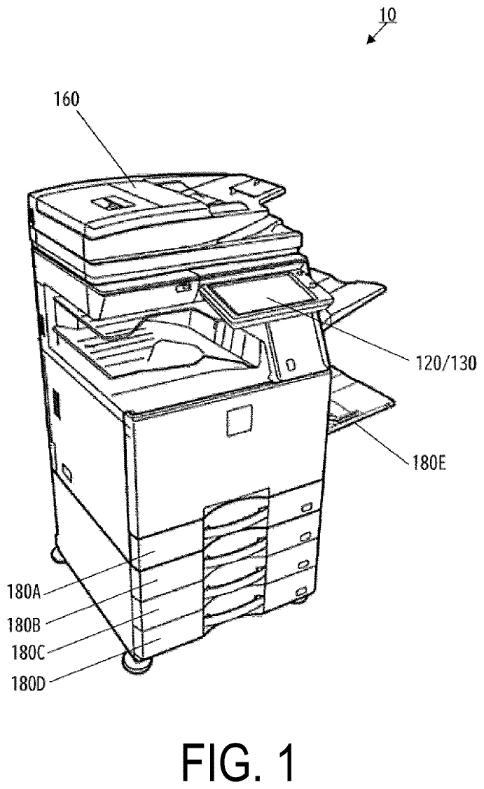

FIG. 1 is an external perspective view of an image forming apparatus 10 according to a first embodiment of the disclosure. The image forming apparatus 10 includes a housing having an upper portion provided with an image inputter 160, and having a front surface provided with a touch display panel that serves as both a display 120 and an operation inputter 130. A bypass tray 180E is provided on a side surface on the right side in the front view of the housing. The housing has a lower portion including a first feed tray 180A, a second feed tray 180B, a third feed tray 180C, and a fourth feed tray 180D in this order from the top. The first feed tray 180A is a feed tray adopting a spring-based sheet lift-up system. The remaining feed trays, that is, the second feed tray 180B, the third feed tray 180C, and the fourth feed tray 180D are feed trays that employ a motor-based sheet lift-up system.

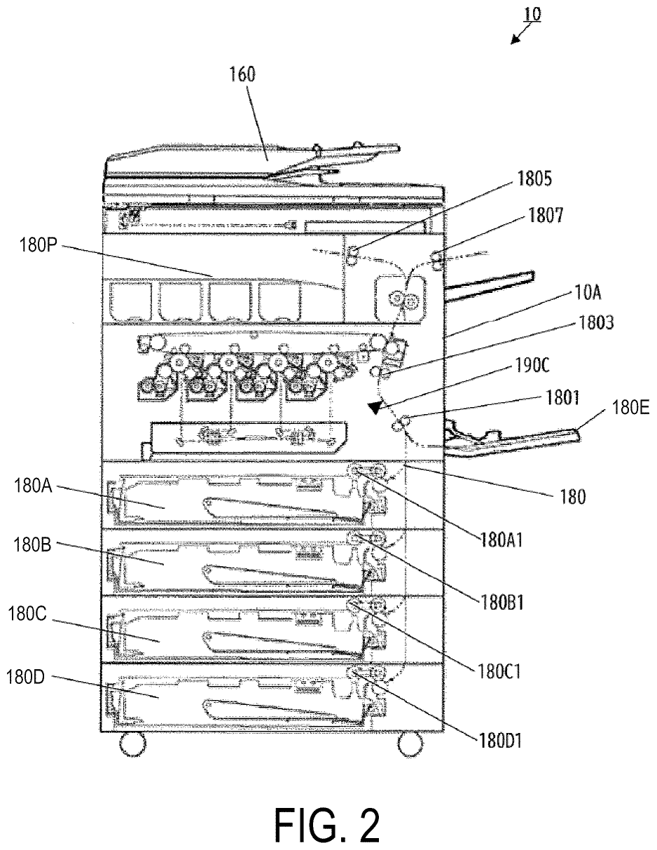

FIG. 2 is a schematic cross-sectional view of the image forming apparatus 10. The first feed tray 180A, the second feed tray 180B, the third feed tray 180C, and the fourth feed tray 180D, respectively include pickup rollers 180A1, 180B1, 180C1, and 180D1, and the sheets set in the respective trays are picked up by these pickup rollers to be conveyed on a feed path. Conveyance rollers 1801, 1803, 1805, and 1807 are provided along the feed path, and these conveyance rollers are controlled by a sheet conveyance controller 100A described below.

A first conveyance sensor 190C is disposed along the feed path. The first conveyance sensor 190C is a sensor for detecting whether there is a sheet at a part of the feed path near the first conveyance sensor 190C.

Further, a conveyance cover (right side cover) 10A is provided along the feed path. The conveyance cover 10A is a cover that can be opened and closed by the user to access the inside of the image forming apparatus 10. The user can open the conveyance cover 10A to remove the jammed sheet on the feed path (for example, near the conveyance roller 1801).

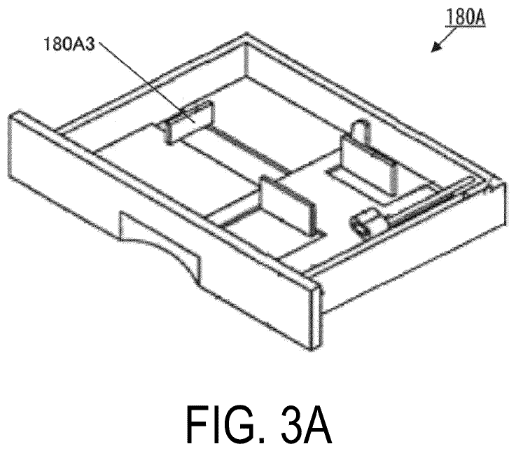

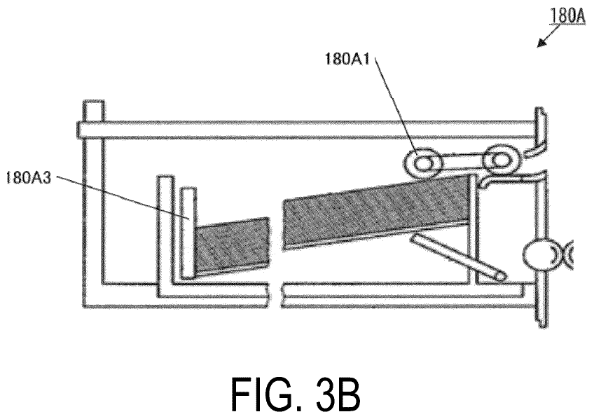

FIG. 3A is a diagram illustrating the first feed tray 180A, and is an external perspective view of the first feed tray 180A. FIG. 3B is a diagram illustrating the first feed tray 180A, and is a schematic cross-sectional view of the first feed tray 180A.

### 1.2 Hardware Configuration

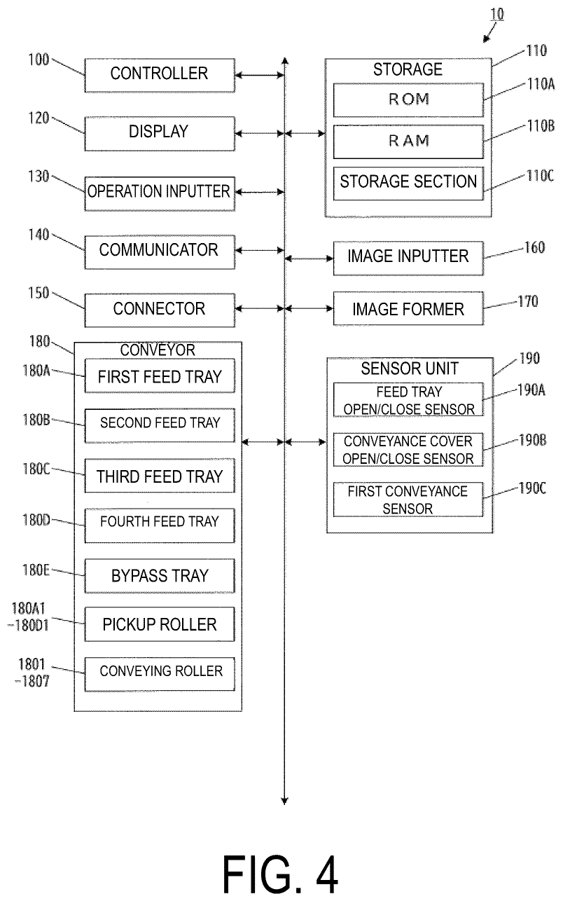

FIG. 4 is a block diagram of the image forming apparatus 10. The image forming apparatus 10 is an image processing apparatus or an information processing apparatus that is also known as a multi-function printer/peripheral (MFP) or a multifunction device, and typically has a copy function, an image scanner function, a facsimile function, and a printer function. The image forming apparatus may further have other functions, such as an email sending and receiving function, a file server function, and the like, for example.

A controller 100 controls the entirety of the image forming apparatus 10. The controller 100 includes one or more control apparatuses or control circuits, and includes, for example, a central processing unit (CPU), which is a processor that executes various arithmetic processes, a system on a chip (SoC), and the like.

In addition, the controller 100 can realize each function by reading programs stored in the storage 110 and executing processing.

A storage 110 stores various programs and various types of data necessary for the operation of the image forming apparatus. The storage 110 includes one or more storage apparatuses that can perform temporary storage, such as a Dynamic Random Access Memory (DRAM) or one or more non-temporary storage apparatuses such as a Solid State Drive (SSD) made of a semiconductor memory or a Hard Disk Drive (HDD) made of a magnetic disk for example. Further, for convenience of explanation, the storage 110 is configured as one unit, but the storage 110 may be configured as separate apparatuses for each purpose, such as an area used for execution of programs (main storage area), an area that stores programs or data (auxiliary storage area), and an area used for caching.

The display 120 displays images and text. For example, the display 120 is configured to include a liquid crystal display (LCD), an organic electro-luminescence (EL) panel, or the like. The display 120 may be a single display apparatus, or may further include a display apparatus connected to the outside.

The operation inputter 130 receives an operation input from a user. For example, the operation inputter 130 is composed of hardware keys and/or software keys. Further, the operation inputter 130 includes task keys for instructing to execute tasks such as fax transmission and image reading, and operation keys such as a cancel key for instructing to cancel an operation, for example. The operation inputter 130 can be configured as a touch panel that can receive input via the display 120. When the operation inputter 130 is configured as the touch panel, the operation inputter can detect a user's touch, tap, swipe, or the like with respect to an object displayed via the display 120, and can acquire a coordinate position, pressure-sensitive information, or the like of touch panel information. In this case, as an input scheme for the touch panel, a general input scheme such as a resistive film scheme, an infrared scheme, an electromagnetic induction scheme, or a capacitive scheme can be adopted for example.

A communicator 140 connects to a network. For example, the communicator 140 is configured to include an interface that can be connected to a wired local area network (LAN), a wireless LAN, or a long term evolution (LTE) network. The communicator 140 is connected to a network for connection to another apparatus or an external network. In addition, the communicator 140 may be an interface for short-distance wireless communication such as near field communication (NFC) or Bluetooth (trade name), for example.

A connector 150 connects the image forming apparatus to another apparatus. For example, the connector 150 is a USB interface to which a USB memory or the like is connected. Further, the connector 150 may be an interface such as HDMI (trade name), in addition to the USB interface.

The image inputter 160 reads out an image (document) and outputs the image as image data. The image inputter 160 includes a typical scanner (image input apparatus). Further, the image inputter 160 may input image data from an external storage medium such as a USB memory, for example, or may receive image data via a network.

An image former 170 forms (prints) an image on a medium such as copy sheet based on the image data. A printing scheme for the image former 170 is freely selected, and may be, for example, any of an inkjet printer, a laser printer, a thermal transfer printer, and the like. The image former 170 may be a monochrome printer or a color printer. The image former 170 may include a paper feed mechanism that supplies the medium, a conveyance mechanism that conveys the medium, a sorter mechanism that sorts the medium after an image is formed, and the like.

A conveyor 180 includes the first feed tray 180A, the second feed tray 180B, the third feed tray 180C, the fourth feed tray 180D, the bypass tray 180E, and a discharge tray 180P. The first feed tray 180A, the second feed tray 180B, the third feed tray 180C, and the fourth feed tray 180D are feed trays that are detachable from the housing of the image forming apparatus 10. The conveyor 180 also includes the pickup rollers 180A1, 180B1, 180C1, and 180D1 that respectively pick up the sheets set in the first feed tray 180A, the second feed tray 180B, the third feed tray 180C, and the fourth feed tray 180D. The conveyor 180 includes the conveyance rollers 1801, 1803, 1805, and 1807 arranged along the feed path.

The conveyor 180 conveys the sheets set in the first feed tray 180A, the second feed tray 180B, the third feed tray 180C, the fourth feed tray 180D, and the bypass tray 180E to the image former 170, using the pickup rollers 180A1, 180B1, 180C1, and 180D1 and the conveyance rollers 1801, 1803, 1805, and 1807. The conveyor 180 conveys the sheet on which the image is formed by the image former 170, to the discharge tray 180P.

A sensor unit 190 includes various sensors provided in the image forming apparatus 10. The sensor unit 190 includes a feed tray open/close sensor 190A, a conveyance cover open/close sensor 190B, and the first conveyance sensor 190C. The sensor unit 190 may further include other sensors.

The feed tray open/close sensor 190A is a sensor that detects an open/closed state of each of the first feed tray 180A, the second feed tray 180B, the third feed tray 180C, and the fourth feed tray 180D. A tray being in the closed state means that the tray is set at a predetermined position inside the housing of the image forming apparatus 10 so that the conveyor 180 can pick up the sheet from the tray. A tray being in the open state means that the conveyor 180 cannot pick up a sheet from the tray, and the tray is at a position shifted from a predetermined position inside the housing of the image forming apparatus 10, or the tray is detached from the housing of the image forming apparatus 10.

The conveyance cover open/close sensor 190B is a sensor for detecting an open/closed state of the conveyance cover (right side cover) 10A.

The first conveyance sensor 190C is a sensor for detecting passing of a sheet through a part of the feed path near the first conveyance sensor 190C.

### 1.3 Software Configuration

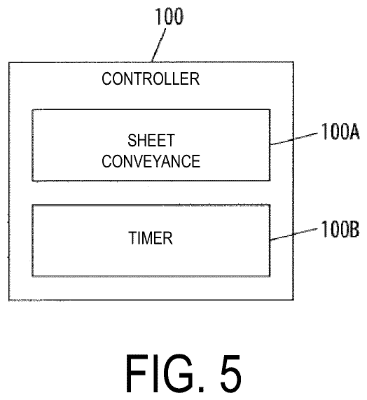

FIG. 5 is a block diagram of the controller 100. The controller 100 includes the sheet conveyance controller 100A and a timer 100B. The sheet conveyance controller 100A conveys a sheet by controlling the rotation of the pickup rollers 180A1, 180B1, 180C1, and 180D1, the conveyance rollers 1801, 1803, 1805, and 1807, and the like disposed on the feed path. The timer 100B generates time information.

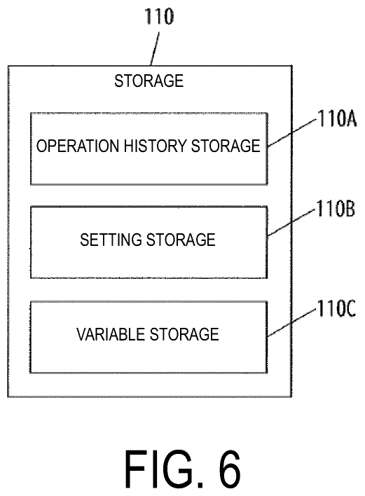

FIG. 6 is a block diagram of the storage 110. The storage 110 includes an operation history storage 110A, a setting storage 110B, and a variable storage 110C.

The operation history storage 110A stores the time when the controller 100 has started the operation of each unit and the time when the operation has ended. For example, the operation history storage 110A stores the time when the conveyance of the sheet has started using the conveyor 180, the time when the conveyance of the sheet has been temporarily stopped, and the time when the conveyance of the sheet has resumed.

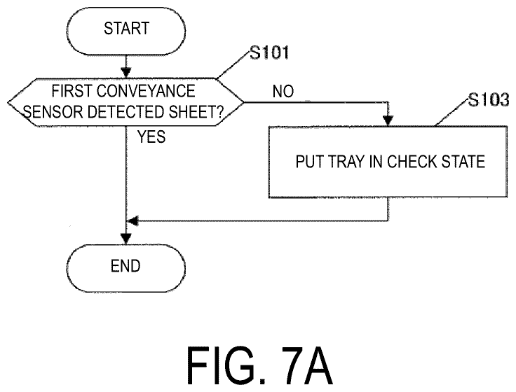

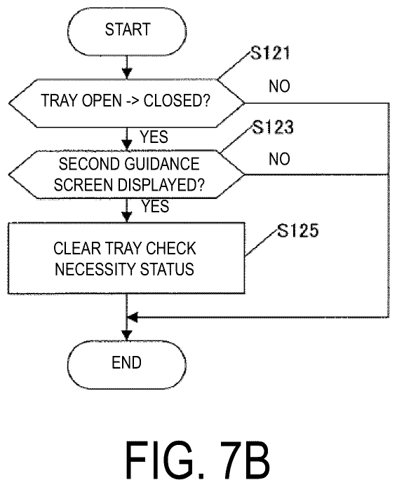

The setting storage 110B stores various setting values set in the image forming apparatus 10. For example, the setting storage 110B stores first jam determination time serving as a threshold to be compared with an elapsed time from when the conveyor 180 has started conveying a sheet from the first feed tray 180A in S101 in FIGS. 7A and 7B described below.

The variable storage 110C stores values of various variables that are referred to when the image forming apparatus 10 operates. In particular, the variable storage 110C stores the current value of the tray checking necessity status of each tray and the history thereof. The tray checking necessity status is a variable indicating whether it is necessary to check the state of the tray. When the value is ON, it indicates that the checking is necessary, and when the value is OFF, it indicates that the checking is not necessary.

### 1.4 Operation

The operation of the image forming apparatus 10 according to the first embodiment will be described. Note that although it is preferable that the following processing be appropriately executed by any of the configurations described in FIG. 5, for convenience of description, the following processing will be described as being executed by the controller 100.

FIGS. 7A and 7B are flowcharts illustrating the operation of the image forming apparatus 10. FIG. 7A is a flowchart illustrating an operation of detecting a conveyance failure that has occurred between the first feed tray 180A and the first conveyance sensor 190C.

The user performs print setting using the operation inputter 130 and instructs the start of printing. It is assumed that the sheet stored in the first feed tray 180A is designated as the sheet to be used for printing by the print setting. The controller 100 starts conveying the sheet from the first feed tray 180A by using the conveyor 180, and stores the time of the start as a conveyance start time in the storage 110.

The controller 100 monitors the output of the first conveyance sensor 190C until the first jam determination time stored in advance in the storage 110 elapses after the conveyance start time (S101).

When the first conveyance sensor 190C detects the sheet before the first jam determination time elapses after the conveyance start time (S101, Yes), the controller 100 directly ends the processing.

On the other hand, when the first conveyance sensor 190C does not detect the sheet until the first jam determination time elapses after the conveyance start time (S101, No), the controller 100 sets the value of the tray checking necessity status, which is a variable given to the first feed tray 180A as the sheet feed source feed tray, to ON (S103), stores the value in the storage 110, and ends the processing.

FIG. 7B is a flowchart illustrating an operation of updating the tray checking necessity status. The controller 100 monitors the open/closed state of each feed tray including the first feed tray 180A by using the feed tray open/close sensor 190A (S121). When the change in the open/closed state of the first feed tray 180A from the open state to the closed state is not detected (S121, No), the processing is terminated.

When the change in the open/closed state of the first feed tray 180A from the open state to the closed state is detected (S121, Yes), the controller 100 determines whether the second guidance screen including a message prompting opening of the first feed tray 180A and the checking of the set state of the sheet, particularly, the positional relationship between the sheet trailing end guide of the first feed tray 180A and the trailing end of the sheet is currently displayed on the display 120 (S123). The second guidance screen will be described in detail below.

When the second guidance screen is determined to be displayed (S123, Yes), the controller 100 sets the value of the tray checking necessity status of the first feed tray 180A to OFF (S125) and ends the processing. When the second guidance screen is determined to not be displayed (S123, No), the controller 100 directly ends the processing.

### 1.5 Operation Example

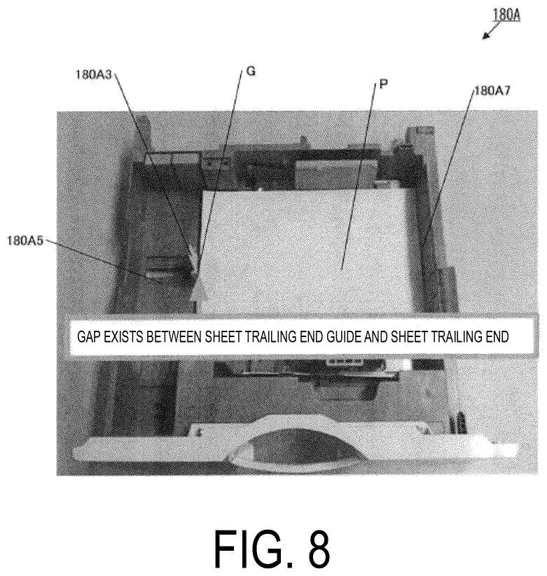

FIG. 8 is a photograph of the first feed tray 180A as viewed from above. The first feed tray 180A includes a sheet trailing end guide 180A3. The first feed tray 180A has a housing with a bottom surface in which a slit 180A5 is open. The sheet trailing end guide 180A3 is movable in the left and right directions in the figure along the slit 180A5. By moving the slit 180A5 to arrange the sheet to be sandwiched between a side surface 180A7 of the housing of the first feed tray 180A and the slit 180A5, sheets of different sizes (such as, for example, A3, A4, B4, and B5) can be accommodated at a predetermined position in the housing of the first feed tray 180A.

When the distance between the sheet trailing end guide 180A3 and the side surface 180A7 is greater than the length of the sheet to be accommodated, a gap G is formed between the sheet trailing end guide 180A3 and a sheet P.

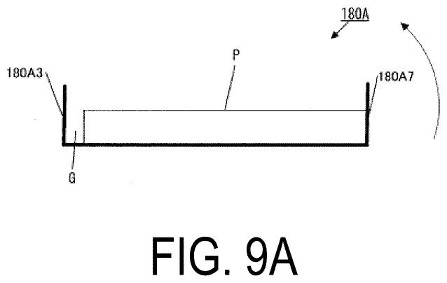

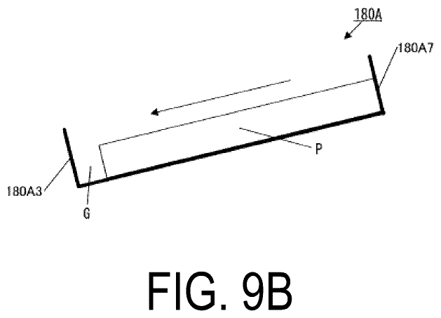

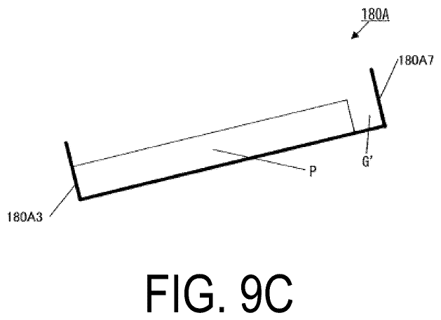

FIGS. 9A to 9C are schematic cross-sectional views illustrating the movement of the sheet that occurs when the first feed tray 180A is lifted up after the sheet is set on the first feed tray 180A in a state where the gap G exists between the sheet trailing end guide 180A3 and the sheet P as illustrated in FIG. 8. FIG. 9A corresponds to the state of FIG. 8. FIG. 9B corresponds to a state immediately after the right side of the first feed tray 180A in the figure is lifted up from the state in FIG. 9A. FIG. 9C corresponds to a state where the sheet P has slipped off from the state illustrated in FIG. 9B.

As illustrated in FIGS. 9A to 9C, when in a state where the gap G exists between the sheet trailing end guide 180A3 and the sheet P, the sheet is set on the first feed tray 180A, and then the right side of the sheet P in the figure is lifted up, the sheet P slips off to move toward the left side in the figure. As a result, the gap G between the sheet trailing end guide 180A3 and the sheet P disappears, but instead, a gap G′ is formed between the side surface 180A7 and the leading end of the sheet P.

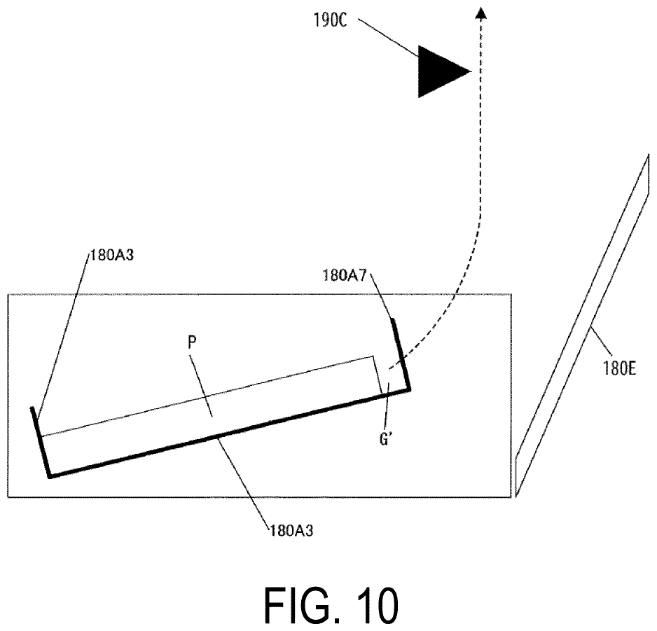

FIG. 10 is a schematic view of a feed path from the first feed tray 180A to the first conveyance sensor 190C. When there is the gap G′ between the leading end of the sheet P and the side surface 180A7, the leading end of the sheet P is deviated from the position originally expected by the pickup roller 180A1 of the first feed tray 180A. Therefore, the pickup roller 180A1 cannot pick up the sheet P from the first feed tray 180A.

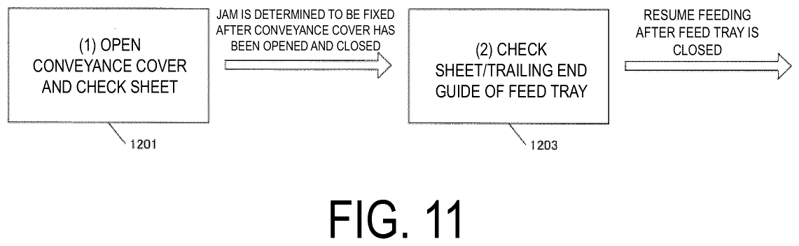

FIG. 11 is a schematic view illustrating a screen transition of the guidance screen displayed on the display 120 of the image forming apparatus 10. Here, it is assumed that the user has designated the first feed tray 180A as the feed source and instructed the image forming apparatus 10 to execute printing using the operation inputter 130. Initially, the first feed tray 180A is in a state of being housed (closed) in the image forming apparatus 10.

The controller 100 detects a failure of conveyance on the feed path from the first feed tray 180A to the first conveyance sensor 190C based on the output of the first conveyance sensor 190C (No in S101 in FIG. 7A). In this case, the controller 100 temporarily stops the conveyance of the sheet by the conveyor 180, sets the value of the variable “tray checking necessity status” of the first feed tray 180A to ON (S103 in FIG. 7A), and displays a first guidance screen 1201 on the display 120.

The first guidance screen 1201 is a screen for displaying a message prompting the user to open the conveyance cover 10A, check whether the sheet on the feed path is jammed (for example, near the conveyance rollers 1801 and 1803), and remove the jammed sheet if the jam is occurring.

The user removes the jammed sheet on the feed path if the jam is occurring, and then closes the conveyance cover 10A, according to the first guidance screen 1201. When the conveyance cover open/close sensor 190B detects a change in the open/closed state of the conveyance cover 10A, the controller 100 determines that the jam on the feed path has been fixed (Yes in S121 in FIG. 7B). At this point, the sheet conveyance by the conveyor 180 is not resumed.

Next, the controller 100 refers to the value of the tray checking necessity status, and displays a second guidance screen 1203 on the display 120 when the value is ON. The second guidance screen 1203 is a screen for displaying a message prompting the user to open the first feed tray 180A, which is the feed source, to check the state of the sheet P, particularly, to check whether there is the gap G between the trailing end of the sheet P and the sheet trailing end guide 180A3, and to adjust the arrangement of the sheet P and the sheet trailing end guide 180A3 so as to eliminate the gap G when there is the gap G.

The user takes out the first feed tray 180A from the image forming apparatus 10 (that is, opens the first feed tray 180A) according to the second guidance screen 1203, adjusts the arrangement of the sheet P and the sheet trailing end guide 180A3 as necessary, and then accommodates the first feed tray 180A in the image forming apparatus 10 (that is, closes the first feed tray 180A).

After displaying the second guidance screen 1203, when the controller 100 detects that the open/closed state of the first feed tray 180A has transitioned from the closed state to the open state and then back to the closed state based on the output of the feed tray open/close sensor 190A, the controller 100 stops displaying the second guidance screen 1203 and resumes the conveyance of the sheet by the conveyor 180.

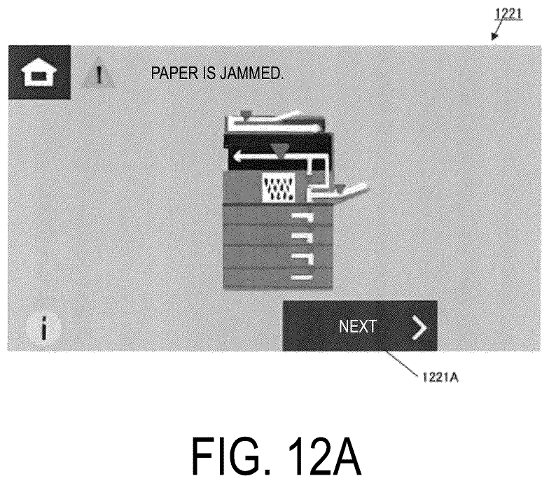

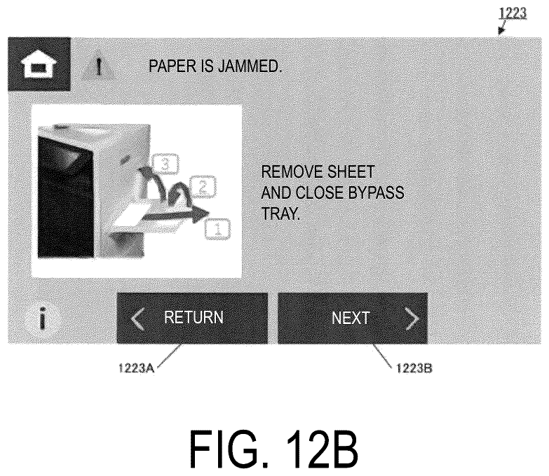

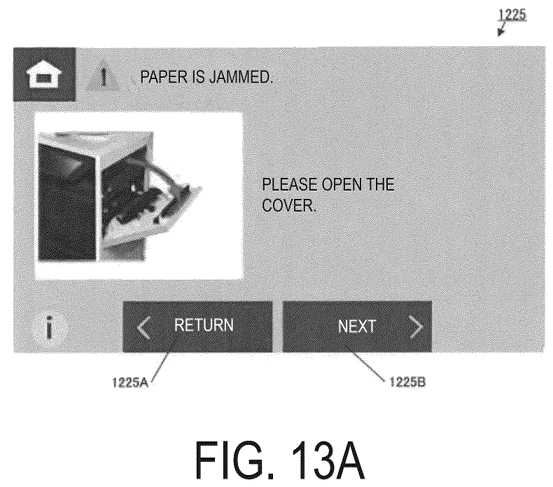

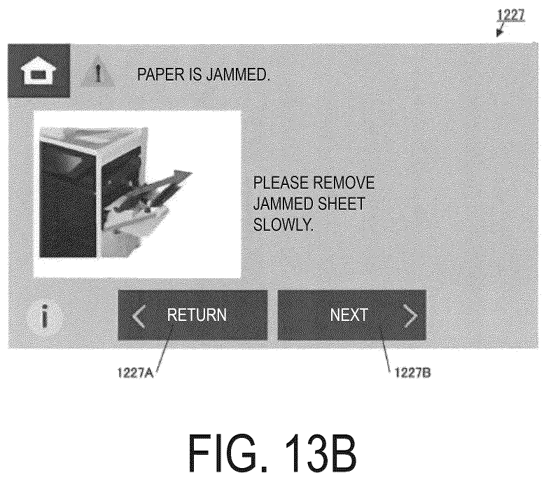

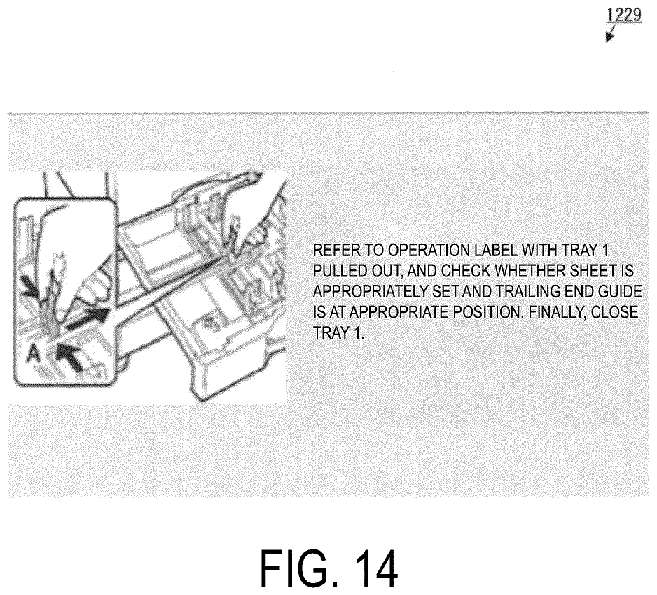

FIGS. 12A and 12B, FIGS. 13A and 13B, and FIG. 14 illustrate an example of the screen displayed on the display 120 of the image forming apparatus 10 according to the first embodiment. A screen 1221 in FIG. 12A is an example of a jam map screen. A screen 1223 in FIG. 12B is an example of a guidance screen for prompting the user to close the bypass tray. A screen 1225 in FIG. 13A and a screen 1227 in FIG. 13B are examples of the first guidance screen 1201. A screen 1229 in FIG. 14 is an example of the second guidance screen 1203.

The screen 1221 is displayed after a failure of conveyance on the feed path from the first feed tray 180A to the first conveyance sensor 190C is detected and before the first guidance screen 1201 is displayed. At the center of the screen 1221, a schematic external view of the image forming apparatus 10 and a white line indicating a feed path inside the image forming apparatus 10 are drawn. A button 1221A is a button for prompting transition to the next screen, and an operation thereon using the operation inputter 130 causes the controller 100 to display the screen 1223 in FIG. 12B on the display 120.

The screen 1223 is a screen displayed after the button 1221A is operated on the screen 1221. On the screen 1223, a perspective view centering on the bypass tray 180E on the right side surface in front view of the image forming apparatus 10 and numbered arrows 1 to 3 indicating a procedure of closing the manual feed tray side 180E are drawn. A button 1223A is a button for prompting transition to the previous screen, and an operation thereon using the operation inputter 130 causes the controller 100 to display the screen 1221 in FIG. 12A on the display 120. A button 1223B is a button for prompting transition to the next screen, and an operation thereon using the operation inputter 130 causes the controller 100 to display the screen 1225 in FIG. 13A on the display 120.

The screen 1225 is a screen displayed after the button 1223B is operated on the screen 1223. On the screen 1225, a perspective view centering on the conveyance cover (described as right side cover in the drawing) 10A on a right side surface in front view of the image forming apparatus 10 and an arrow curve indicating how to open the conveyance cover 10A are drawn. A button 1225A is a button for prompting transition to the previous screen, and an operation thereon using the operation inputter 130 causes the controller 100 to display the screen 1223 in FIG. 12B on the display 120. A button 1225B is a button for prompting transition to the next screen, and an operation thereon using the operation inputter 130 causes the controller 100 to display the screen 1227 in FIG. 13B on the display 120.

The screen 1227 is a screen displayed after the button 1225B is operated on the screen 1225. On the screen 1227, a perspective view centering on the conveyance cover 10A on the right side surface in front view of the image forming apparatus 10 and an arrow indicating a direction in which a jammed sheet is taken out through the opened conveyance cover 10A are drawn. A button 1227A is a button for prompting transition to the previous screen, and an operation thereon using the operation inputter 130 causes the controller 100 to display the screen 1225 in FIG. 13A on the display 120. A button 1227B is a button for prompting transition to the next screen, and an operation thereon using the operation inputter 130 causes the controller 100 to display the screen 1229 in FIG. 14 on the display 120.

The screen 1229 is a screen displayed after the button 1227B is operated on the screen 1227. The screen 1229 illustrates the adjustment of the positions of the sheet trailing end guide 180A3 and the sheet P using a schematic perspective view of the first feed tray 180A taken out from the image forming apparatus 10, and particularly illustrates a procedure of adjusting the position of the sheet trailing end guide 180A3. More specifically, the screen 1229 indicates adjustment of the position of the sheet trailing end guide 180A3 by holding a knob in the upper portion of the sheet trailing end guide 180A3 and then moving the sheet trailing end guide 180A3 along the slit 180A5. Further, the screen 1229 displays a message prompting the user to close the first feed tray 180A3 (set the first feed tray 180A at a predetermined position of the image forming apparatus 10) after the position adjustment of the sheet trailing end guide 180A3 and the sheet P.

When the image forming apparatus 10 is powered on again after the image forming apparatus 10 is powered off in a state where the second guidance screen 1203 (the screen 1229) is displayed, or when the image forming apparatus 10 is rebooted, the controller 100 does not display the second guidance screen 1203 (the screen 1229) on the display 120.

### 1.6 Effects

According to the first embodiment, after the jam is detected and the conveyance of the sheet is temporarily stopped, the first guidance screen 1201 is displayed, and opening and closing the conveyance cover 10A does not simply lead to resumption of the conveyance of the sheet. After the first guidance screen 1201 is displayed and the conveyance cover 10A is opened and closed, the second guidance screen 1203 is further displayed, and after the first feed tray 180A is opened and closed, the sheet conveyance is resumed. Therefore, according to the first embodiment, when the jam that has occurred is caused by the state of the sheet in the first feed tray 180A, the user can be reliably prompted to open the first feed tray 180A for checking.

### 2. Second Embodiment

Next, a second embodiment will be described. Hereinafter, only parts of the configuration and processing different from the first embodiment will be mainly described.

### 2.1 Hardware Configuration

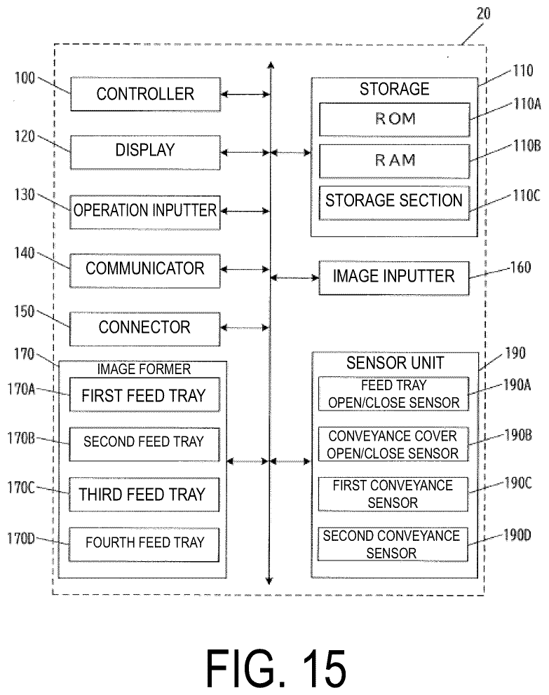

FIG. 15 is a block diagram of an image forming apparatus 20. The image forming apparatus 20 is different from the image forming apparatus 10 in that a second conveyance sensor 190D is further provided in addition to the first conveyance sensor 190C.

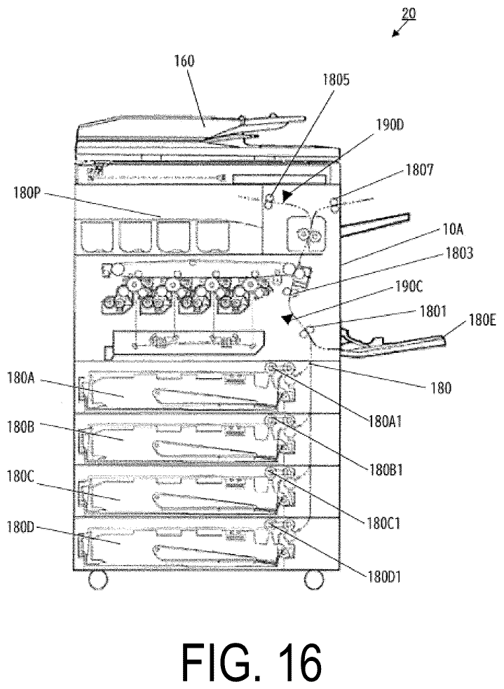

FIG. 16 is a schematic cross-sectional view of the image forming apparatus 20. As illustrated in the figure, the second conveyance sensor 190D is positioned downstream of the first conveyance sensor 190C in the feed path.

### 2.2 Operation

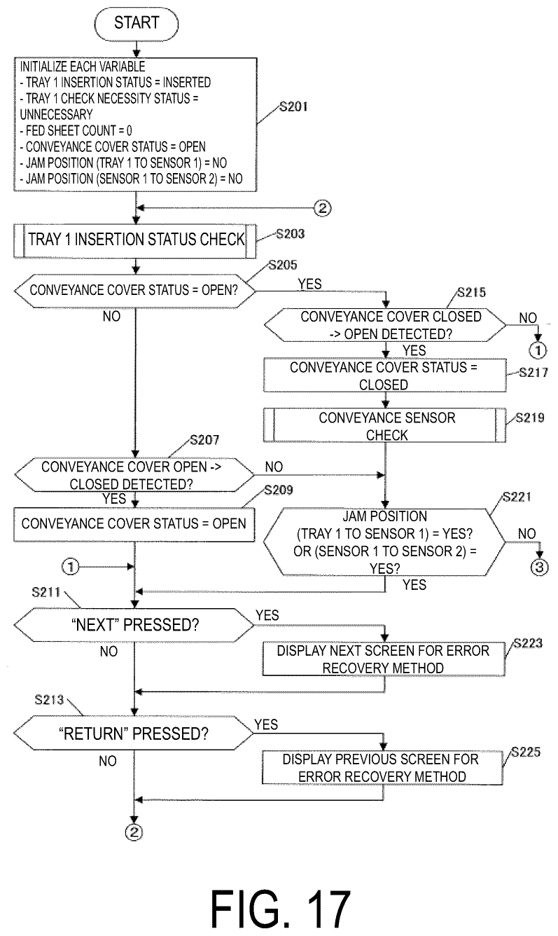

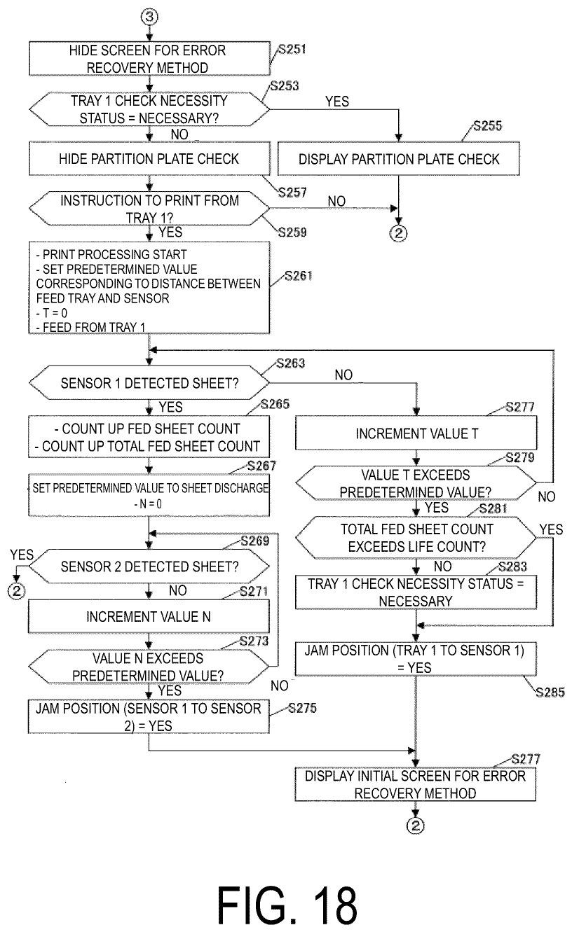

FIG. 17 and FIG. 18 are flowcharts illustrating an operation of the image forming apparatus 20. The flowchart in FIG. 17 is executed by the controller 100 when the image forming apparatus 20 is powered on. The screens for the error recovery methods (including the initial screen of the error recovery method displayed in S277, the subsequent screen of the error recovery method displayed in S223, and the previous screen of the error recovery method displayed in S225) in the present embodiment correspond to the first guidance screen 1201 in the first embodiment, and partition plate checking displayed in S255 corresponds to the second guidance screen 1203 in the first embodiment. First, the controller 100 initializes the following variables (S201). That is, the variable “tray 1 insertion status” is initialized to “inserted”. The variable “Tray 1 checking necessity status” is initialized to “unnecessary”. The variable “fed sheet count” is initialized to “0”. The variable “conveyance cover status” is initialized to “open”. The variable “jam position (TRAY 1 to sensor 1)” is initialized to “no”. The variable “jam position (sensor 1 to sensor 2)” is initialized to “no”.

The variable “tray 1 insertion status” and “tray 1 checking necessity status” correspond to the first feed tray 180A. The variable “conveyance cover status” corresponds to the conveyance cover 10A. The variable “jam position (TRAY 1 to sensor 1)” corresponds to any one of the first feed tray 180A, the second feed tray 180B, the third feed tray 180C, and the fourth feed tray 180D, and the first conveyance sensor 190C. The variable “jam position (sensor 1 to sensor 2)” corresponds to the first conveyance sensor 190C and the second conveyance sensor 190D.

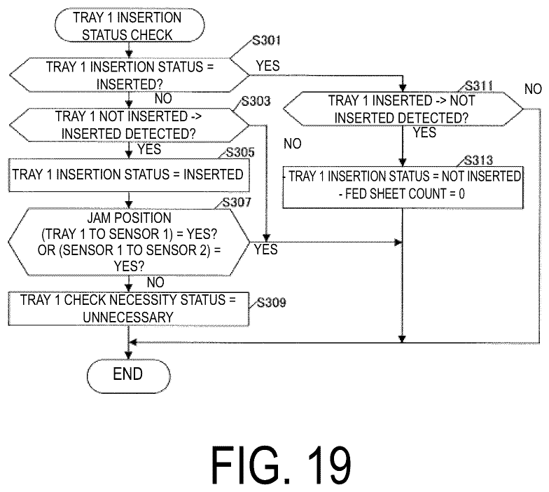

Next, the controller 100 executes tray 1 insertion status checking processing (FIG. 19) described below (S203). The controller 100 determines whether the value of the variable “conveyance cover status” is “open” (S205). When the value of the variable “conveyance cover status” is “closed” (S205, No), the controller 100 determines whether the open/closed state of the conveyance cover 10A has transitioned from the closed state to the open state based on the output of the conveyance cover open/close sensor 190B (S207).

Upon determining that the open/closed state of the conveyance cover 10A has transitioned from the closed state to the open state (S207, Yes), the controller 100 sets the value of the variable “conveyance cover status” to “open” (S209). Thereafter, the controller 100 determines whether a “next” button has been pressed on the screen for the error recovery method (S211). When the “next” button is pressed (S211, Yes), the controller 100 displays the next screen for the error recovery method on the display 120 (S223). When the “next” button is not pressed (S211, No), the controller 100 determines whether a “return” button is pressed on the screen for the error recovery method (S213). When the “return” button is pressed (S213, Yes), the controller 100 displays (S225) the previous screen for the error recovery method on the display 120, and returns to S203. When the “return” button is not pressed (S213, No), the controller 100 directly returns to S203. The screen for the error recovery method is any one of the screens illustrated in FIGS. 12A and 12B and FIGS. 13A and 13B. The “next” button is any one of the buttons 1221A, 1223B, 1225B, and 1227B. The “return” button is any one of the buttons 1223A, 1225A, and 1227A.

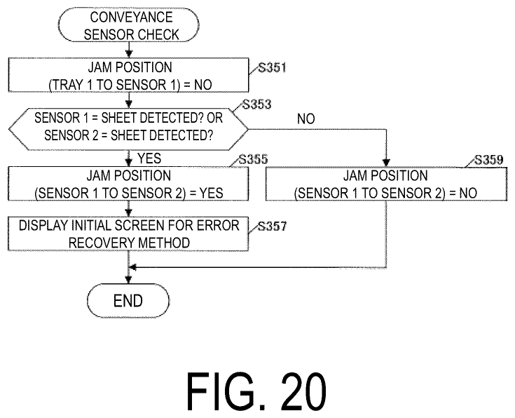

Upon determining in S205 that the variable “conveyance cover status” is “open” (S205, Yes), the controller 100 determines whether the open/closed state of the conveyance cover 10A has transitioned from “open” to “closed” based on the output of the conveyance cover open/close sensor 190B (S215). When the transition has not occurred (S215, No), the controller 100 proceeds to S211. When the transition has occurred (S215, Yes), the controller 100 sets the value of the variable “conveyance cover status” to “closed” (S217), executes conveyance sensor check processing (FIG. 20) described below (S219), and then determines whether the value of the variable “jam position (TRAY 1 to sensor 1)” is “yes” or the value of the variable “jam position (sensor 1 to sensor 2)” is “yes” (S221). When the value of the variable “jam position (TRAY 1 to sensor 1)” or the variable “jam position (sensor 1 to sensor 2)” is “yes” (S221, Yes), the controller 100 proceeds to S211. When both of the values of the variables “jam position (TRAY 1 to sensor 1)” and “jam position (sensor 1 to sensor 2)” are “no” (S221, No), the controller 100 proceeds to S251 described next.

In S251, the controller 100 hides the screen for the error recovery method, and determines whether the value of the variable “tray 1 checking necessity status” is “necessary” (S253). When the value of the variable “tray 1 checking necessity status” is “necessary” (S253, Yes), the controller 100 displays partition plate check (S255), and proceeds to S203. The partition plate check is the second guidance screen 1203, and is, for example, the screen 1229 in FIG. 14.

When the value of the variable “tray 1 checking necessity status” is “unnecessary” (S253, No), the controller 100 determines whether there is a print instruction designating the tray 1 (first feed tray 180A) (S259) without displaying the partition plate check (S257). When there is no print instruction designating the tray 1 (S259, No), the processing proceeds to S203. When there is the print instruction designating the tray 1 (S259, Yes), the controller 100 starts the print processing with the tray 1 as the feed source (S261). In this case, the controller 100 sets the predetermined value according to the distance between the first feed tray 180A and the first conveyance sensor 190C. The controller 100 sets a variable T having an initial value of zero.

Next, the controller 100 determines whether the sensor 1 (first conveyance sensor 190C) has detected the sheet (S263). When the first conveyance sensor 190C does not detect the sheet (S263, No), the controller 100 adds a predetermined value (for example, 1) to the value of the variable T (S277), and then compares the value of the variable T after the addition with the predetermined value set in S261 (S279). When the value T does not exceed the predetermined value (S279, No), the controller 100 returns to S263.

When the value T exceeds the predetermined value (S279, Yes), it means that the sensor 1 has not detected the sheet even when the value T exceeds the predetermined value after the printing processing using the tray 1 as the feed source tray starts. In this case, the controller 100 determines whether the total fed sheet count exceeds the life count (S281). The life count is a value given to each of the tray 1 and the tray 2, and is a value of the upper limit of the number of times (the number of sheets) the normal operation of the sheet feeding from the tray is guaranteed. When the total fed sheet count does not exceed the life count (S281, No), the controller 100 sets the value of the variable “Tray 1 checking necessity status” of the first feed tray 180A to “necessary” (S283), sets the value of the variable “jam position (TRAY 1 to sensor 1)” to “yes” (S285), and proceeds to S277. When the total fed sheet count exceeds the life count (S281, Yes), the controller 100 skips S283 and proceeds to S285, and then proceeds to S277. In S277, the controller 100 displays an initial screen (for example, the screen 1221 in FIG. 12A) for the error recovery method on the display 120, and proceeds to S203.

When the first conveyance sensor 190C detects a sheet in S263 (S263, Yes), the controller 100 adds 1 to each of the variables “fed sheet count” and “total fed sheet count” (S265), and sets a predetermined value until sheet discharge and a variable N with an initial value of zero (S267). Next, the controller 100 determines whether a sensor 2 (second conveyance sensor 190D) has detected the sheet (S269). When the sensor 2 detects the sheet (S269, Yes), the controller 100 proceeds to S203. When the sensor 2 does not detect the sheet (S269, No), the controller 100 adds a predetermined value to the variable N (S271), and compares the value of the variable N after the addition with the predetermined value determined in S267 (S273). When the variable N does not exceed the predetermined value determined in S267 (S273, No), the controller 100 returns to S269. When the variable N exceeds the predetermined value determined in S267 (S273, Yes), the controller 100 sets the value of the variable “jam position (sensor 1 to sensor 2)” to “yes” (S275), and proceeds to S277 and S203.

FIG. 19 is a flowchart of insertion status checking processing for the tray 1 in S203 in FIG. 17. The controller 100 determines whether the value of the variable “tray 1 insertion status” is “inserted” (S301). When the value of the variable “tray 1 insertion status” is “not inserted” (S301, No), the controller 100 determines whether the state of the tray 1 has transitioned from the state of not being inserted in the image forming apparatus 20 to the state of being inserted in the image forming apparatus 20 based on the output of the feed tray open/close sensor 190A (S303). Upon determining that the state has transitioned to the inserted state (S303, Yes), the controller 100 sets the value of the variable “TRAY 1 insertion status” to “inserted” (S305), and determines whether the value of the variable “jam position (TRAY 1 to sensor 1)” is “yes” or the value of the variable “jam position (sensor 1 to sensor 2)” is “yes” (S307). In S303, upon determining that the state of the tray 1 has not transitioned from the state in which the tray 1 is not inserted into the image forming apparatus 20 to the state in which the tray 1 is inserted into the image forming apparatus 20 (S303, No), the controller 100 ends the insertion status checking processing for the tray 1.

When both the values of the variables “jam position (TRAY 1 to sensor 1)” and “jam position (sensor 1 to sensor 2)” are “no” (S307, No), the controller 100 sets the value of the variable “TRAY 1 checking necessity status” to “unnecessary” (S309), and ends the insertion status checking processing for the tray 1.

When at least one of the values of the variables “jam position (TRAY 1 to sensor 1)” and “jam position (sensor 1 to sensor 2)” is “yes” (S307, Yes), the controller 100 directly ends the insertion status checking processing for the tray 1.

Upon determining in S301 that the value of the variable “tray 1 insertion status” is “inserted” (S301, Yes), the controller 100 determines whether the state of the tray 1 has transitioned from the state of being inserted in the image forming apparatus 20 to the state of not being inserted based on the output of the feed tray open/close sensor 190A (S311). Upon determining that the transition has not occurred (S311, No), the controller 100 ends the insertion status checking processing for the tray 1.

Upon determining that the transition has occurred (S311, Yes), the controller 100 sets the value of the variable “tray 1 insertion status” to “not inserted”, sets the value of the variable “fed sheet count” to zero (S313), and ends the insertion status checking processing for the tray 1.

FIG. 20 is a flowchart of the conveyance sensor check processing in S219 in FIG. 17. The controller 100 sets the value of the variable “jam position (TRAY 1 to sensor 1)” to “no” (S351), and determines whether the sensor 1 and the sensor 2 have actually detected the sheet based on the outputs of the sensor 1 (first conveyance sensor 190C) and the sensor 2 (second conveyance sensor 190D) (S353).

When at least one of the sensor 1 and the sensor 2 has detected the sheet (S353, Yes), the controller 100 sets the value of the variable “jam position (sensor 1 to sensor 2)” to “yes” (S355), displays the initial screen (for example, the jam map screen 1221 of FIG. 12A) for the error recovery method on the display 120 (S357), and ends the conveyance sensor check processing.

In S353, when both of the sensor 1 and the sensor 2 have not detected the sheet (S353, No), the controller 100 sets the value of the variable “jam position (sensor 1 to sensor 2)” to “no” (S359), and ends the conveyance sensor check processing.

### 2.3 Effects

According to the second embodiment, when the sensor 1 fails to detect the sheet (S263, No), the tray 1 checking necessity status is changed to “necessary” (S283), and whether to display the partition plate check (second guidance screen 1203) can be determined (S253) depending on whether the value of the tray 1 checking necessity status is necessary or unnecessary.

### 3. Third Embodiment

A third embodiment will now be described. In the third exemplary embodiment, the image forming apparatus 10 is used. Hereinafter, only parts of the configuration and processing different from the first embodiment will be mainly described.

The first feed tray 180A, the second feed tray 180B, the third feed tray 180C, and the fourth feed tray 180D are different in the system of lifting up the sheet. The first feed tray 180A adopts a system (spring system) of lifting up the sheet by using a spring. The second feed tray 180B, the third feed tray 180C, and the fourth feed tray 180D adopt a system (motor system) of lifting up the sheet using a motor. In the case of the spring system, the sheet is lifted up with great force, and as a result, the position of the sheet may be shifted as described with reference to FIGS. 9A to 9C. On the other hand, in the case of the motor type, since the sheet is slowly lifted up, the positional deviation of the sheet due to the lift-up is less likely to occur. In view of this, in the third embodiment, whether to display the second guidance screen is changed according to the lift-up system of the feed tray as the feed source.

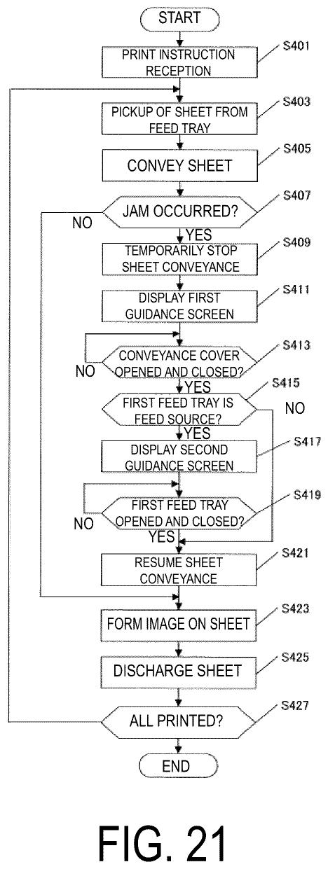

FIG. 21 is a flowchart illustrating an operation of the image forming apparatus 10 according to the third embodiment. The controller 100 receives a print instruction via the operation inputter 130. The print instruction includes designation of a feed tray storing sheets to be used for the printing. Specifically, the print instruction includes designation of any one of the first feed tray 180A, the second feed tray 180B, the third feed tray 180C, and the fourth feed tray 180D. Next, the controller 100 picks up one sheet using the pickup roller for the feed tray designated by the print instruction (S403). Next, the controller 100 conveys the picked-up sheet by using the conveyor 180 (S405). Next, the controller 100 determines whether a jam has occurred between the feed tray as the feed source and the first conveyance sensor 190C based on the output of the first conveyance sensor 190C (S407).

More specifically, for each of the first feed tray 180A, the second feed tray 180B, the third feed tray 180C, and the fourth feed tray 180D, the time normally required for the sheet to pass through the first conveyance sensor 190C from the feed tray as the feed source when the sheet is measured in advance, and a threshold determined based on the required time is stored in the setting storage 110B for each feed tray. The controller 100 compares the required time from the execution of S403 with the threshold for the feed tray as the feed source, and determines that the jam has occurred between the feed tray as the feed source and the first conveyance sensor 190C when the required time exceeds the threshold.

Upon determining that jam has not occurred between the feed tray as the feed source and the first conveyance sensor 190C (S407, No), the controller 100 proceeds to S423 described below. Upon determining that jam has occurred (S407, Yes), the controller 100 temporarily stops the conveyance of the sheet by the conveyor 180 (S409), and displays the first guidance screen 1201 using the display 120 (S411). The controller 100 determines whether the open/closed state of the conveyance cover 10A has transitioned to the open state and then to the closed state based on the output of the conveyance cover open/close sensor 190B (S413). Upon determining that the conveyance cover 10A has not been opened and closed (S413, No), the controller 100 repeats S413. Upon determining that the conveyance cover 10A has been opened and closed (S413, Yes), the controller 100 further determines whether the feed tray as the feed source is the first feed tray 180A (S415).

Upon determining that the feed tray as the feed source is the first feed tray 180A (S415, Yes), the controller 100 displays (S417) the second guidance screen 1203 using the display 120, and then determines whether the open/closed state of the first feed tray 180A has transitioned to the open state and then to the closed state based on the output of the feed tray open/close sensor 190A (S419). Upon determining that the first feed tray 180A has not been opened and closed (S419, No), the controller 100 repeats S419. Upon determining that the first feed tray 180A has been opened and closed (S419, Yes), the controller 100 resumes the conveyance of the sheet by using the conveyor 180, forms an image on the sheet by using the image former 170 (S423), and discharges the sheet to the sheet discharge tray 180P (S425). The controller 100 determines whether all the printing instructions in S401 have been completed (S427), and if not completed, returns to S403 and picks up a new sheet from the first feed tray 180A to continue the printing, and if completed, ends the processing.

On the other hand, when the controller 100 determines that the feed tray as the feed source is any one of the second feed tray 180B, the third feed tray 180C, and the fourth feed tray 180D in S415 (S415, No), the controller 100 proceeds to S421. In this case, the second guidance screen 1203 is not displayed.

According to the third embodiment, when a jam occurs between the feed tray as the feed source and the first conveyance sensor 190C with the first feed tray 180A being the feed source, both the first guidance screen 1201 and the second guidance screen 1203 are displayed to guide the user to open and close both the conveyance cover 10A and the first feed tray 180A, and the conveyance of the sheet is resumed after both the conveyance cover 10A and the first feed tray 180A are opened and closed. On the other hand, when the feed source is not the first feed tray 180A, only the first guidance screen 1201 is displayed, whereby the user is prompted to open and close the conveyance cover 10A without being prompted to open and close the first feed tray 180A. The conveyance of the sheet is resumed after the conveyance cover 10A is opened and closed.

Therefore, according to the third embodiment, the portion that the user needs to check when a jam occurs can be limited according to the type of the feed tray as the feed source.

### 4. Variations

The disclosure is not limited to the embodiments and variations described above, and various variations are possible. In other words, the technical scope of the disclosure also includes embodiments obtained by combining technical means that are appropriately modified within the scope of the gist of the disclosure.

The programs running on each apparatus in the embodiments are programs for controlling a CPU or the like (programs for causing a computer to function) to enable the aforementioned functions in the embodiments described above. Information handled by these apparatuses is temporarily accumulated in a temporary storage apparatus (for example, a RAM) during processing, and is then stored in storage apparatuses such as various read only memories (ROM), HDDs, and solid state drives (SSD), and is read, modified, and written by a CPU as necessary.

The recording medium storing the programs may be any of a semiconductor medium (for example, a ROM or a nonvolatile memory card), an optical recording medium or a magneto-optical recording medium (for example, a digital versatile disc (DVD), a magneto optical disc (MO), a mini disc (MD), a compact disc (CD), or a Blu-ray (trade name) disc (BD)), a magnetic recording medium (for example, a magnetic tape or a flexible disk), and the like. Further, not only are the functions of the above-described embodiments enabled by executing the loaded program, but the functions of the disclosure may also be enabled by processing in cooperation with an operating system or another application program or the like, based on instructions from the program.

Further, when a program is distributed in a market, the program can be stored in a portable recording medium and distributed, or can be transferred to a server computer connected via a network such as the Internet. In this case, it is obvious that a storage apparatus of the server computer is also included in the disclosure.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An image forming apparatus comprising:
at least one controller;
a first feed tray that accommodates a sheet;
a second feed tray that accommodates a sheet; and
a display, wherein
the at least one controller
stops, when a jam occurs and the first feed tray is a feed source, conveyance of the sheet, displays a feed tray opening/closing request message, prompting opening and closing of the first feed tray, on the display, and then resumes the conveyance of the sheet, and
stops, when the jam occurs and the second feed tray is the feed source, the conveyance of the sheet, and then resumes the conveyance of the sheet without displaying a message prompting opening and closing of the second feed tray on the display.

2. The image forming apparatus according to claim 1, wherein the first feed tray lifts up the sheet using a spring, and the second feed tray lifts up the sheet using a motor.

3. The image forming apparatus according to claim 1, further comprising a conveyance cover that is openable and closable, and covers an opening through which the jammed sheet is able to be taken out from inside a housing of the image forming apparatus, wherein
the at least one controller displays on the display, a message prompting opening of the conveyance cover and checking of the inside of the housing in response to the occurrence of the jam.

4. The image forming apparatus according to claim 1, wherein the first feed tray is disposed above the second feed tray.

5. A control method for an image forming apparatus including a first feed tray that accommodates a sheet, a second feed tray that accommodates a sheet, and a display, the method comprising:
stopping, when a jam occurs and the first feed tray is a feed source, conveyance of the sheet, displaying a feed tray opening/closing request message, prompting opening and closing of the first feed tray, on the display, and then resuming the conveyance of the sheet; and
stopping, when the jam occurs and the second feed tray is the feed source, the conveyance of the sheet, and then resuming the conveyance of the sheet without displaying a message prompting opening and closing of the second feed tray on the display.
